(19) United States
(12) Patent Application Publication
(10) Pub. No.: US 2009/0237192 A1
(43) Pub. Date: Sep. 24, 2009

(54) MAGNETIC RESONANCE IMAGING SYSTEM AND APPARATUS HAVING A MULTIPLE-SECTION

(75) Inventor: Timothy James Hollis, Langford Village (GB)

Correspondence Address: RAMIREZ & SMITH, PO BOX 341179, AUSTIN, TX, 78734, US

(73) Assignee: GENERAL ELECTRIC COMPANY, Schenectady, NY (US)

(21) Appl. No.: 12/052,545

(22) Filed: Mar. 20, 2008

(51) Int. Cl. H01F 5/00

(52) U.S. Cl. 335/299

(57) ABSTRACT

Systems, methods and apparatus are provided through which in some embodiments a magnetic resonance imaging system includes at least two cryostats, each cryostat having a portion of a superconducting coil. Some embodiments provide force balancing between the sections. Some embodiments provide an ability to use more efficient superconducting coil geometry which would otherwise physically trap the gradient between the coils. Some embodiments provide an ability to install, remove or upgrade magnet without dismantling the imaging room.

### FIELD OF THE INVENTION

This invention relates generally to magnetic resonance imaging systems, and more particularly to a multi-section magnet for a magnetic resonance imaging system.

### BACKGROUND OF THE INVENTION

Magnetic resonance imaging (MRI) is a technique in which an object is placed in an electromagnetic field and subjected to pulses of the electromagnetic field at a frequency. The pulses cause nuclear magnetic resonance in the object and the spectra obtained thereby is processed numerically to form cross-sectional images of the object. MRI imaging is especially useful for medical or veterinary applications because different living tissues emit different characteristics of resonance signals, thus enabling visualization of the different living tissues in the obtained image. An MRI apparatus thus operates in general by the application of a radio frequency (RF) electromagnetic field in the presence of other magnetic fields, and the subsequent sensing and analysis of the resulting nuclear magnetic resonances induced in the body.

Conventional MRI systems include a main magnet which generates a strong static magnetic field of a high temporal stability and a high spatial homogeneity within a field-of-view (FOV) where the imaging takes place. Conventional MRI systems also include a gradient coil assembly located in the bore between the main magnet and an RF coil. The gradient coil assembly generates space-varying fields that cause the response frequency and phase of the nuclei of the patient body to depend upon position within the FOV thus providing a spatial encoding of the body-emitted signal. Conventional MRI systems further include RF coil/coils arranged within the bore which emit RF waves and receive resonance signal from the body. The main magnet may be a superconducting magnet that includes a plurality of concentric coils placed inside a cryostat which is designed to provide a low temperature operating environment for superconducting coils.

### BRIEF DESCRIPTION OF THE INVENTION

In accordance with an embodiment, an apparatus includes a first section of a superconducting coil operable to generate a magnetic field. The first section of the superconducting coil is contained in a first cryostat. The apparatus also includes a second section of the superconducting coil. The second section of the superconducting coil contained in a second cryostat.

In accordance with another embodiment, a system includes a plurality of cryostats. Each cryostat contains a section of a superconducting coil operable to generate a magnetic field. The system also includes a gradient coil positioned at a radius inward of the plurality of cryostats.

In accordance with another embodiment, a magnetic resonance imaging system includes a gradient coil and a first cryostat having at least a portion positioned at a first end of the gradient coil. The first cryostat contains a first set of superconducting coils including a first bucking coil and a first section of a primary coil. The first section of the primary coil is operable to generate a magnetic field. The magnetic resonance imaging system also includes a second cryostat having at least a portion positioned at a second end of the gradient coil, the second cryostat containing a second set of superconducting coils including a second bucking coil and a second section of the primary coil. The second section of the primary coil is operable to generate a magnetic field. At least one of the first set of superconducting coils and the second set of superconducting coils is removable from the magnetic resonance imaging system.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a simplified cross section block diagram of a magnetic resonance imaging system having at least two cryostats, according to an embodiment;

FIG. 2 is a simplified cross section block diagram of magnetic resonance imaging system having at least two cryostats, according to an embodiment;

FIG. 3 is a simplified cross section block diagram of magnetic resonance imaging system having two sections of a superconducting magnet enclosed in separate cryostats, according to an embodiment;

FIG. 4 is an isometric diagram of a conventional MRI transverse gradient magnetic field body coil that is compatible with the MRI system of FIGS. 1-3, according to an embodiment;

FIG. 5 is a cross section diagram of a conventional transverse gradient coil that is compatible with the MRI system of FIGS. 1-3, according to an embodiment;

FIG. 6 and FIG. 7 are cross section diagrams of a transverse folded single layer continuous gradient coil that is compatible with the MRI system of FIGS. 1-3, according to an embodiment; and

FIG. 8 is cross section diagram of a crescent gradient coil that is compatible with the MRI system of FIGS. 1-3, according to an embodiment.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

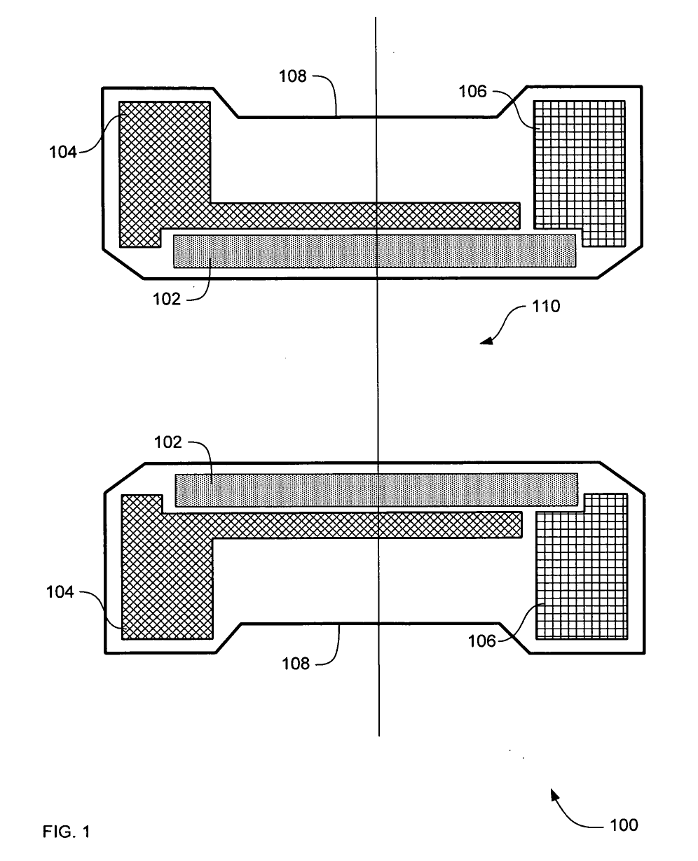

FIG. 1 is a simplified cross section block diagram of a magnetic resonance imaging (MRI) system 100 having at least two cryostats, according to an embodiment. MRI system 100 includes a gradient coil 102. MRI system 100 also includes a first cryostat 104 and a second cryostat 106. The gradient coil 102, the first cryostat 104 and the second cryostat 106 are enclosed in a housing 108 that surrounds a cylindrical patient volume or bore 110. Various other elements of MRI system 100 such as an RF coil (or coils), suspension members, brackets, a patient table or support, etc. are omitted from FIG. 1 for clarity. In FIG. 1, two cryostats 104 and 106 are shown, however, in other embodiments more than two cryostats may be used.

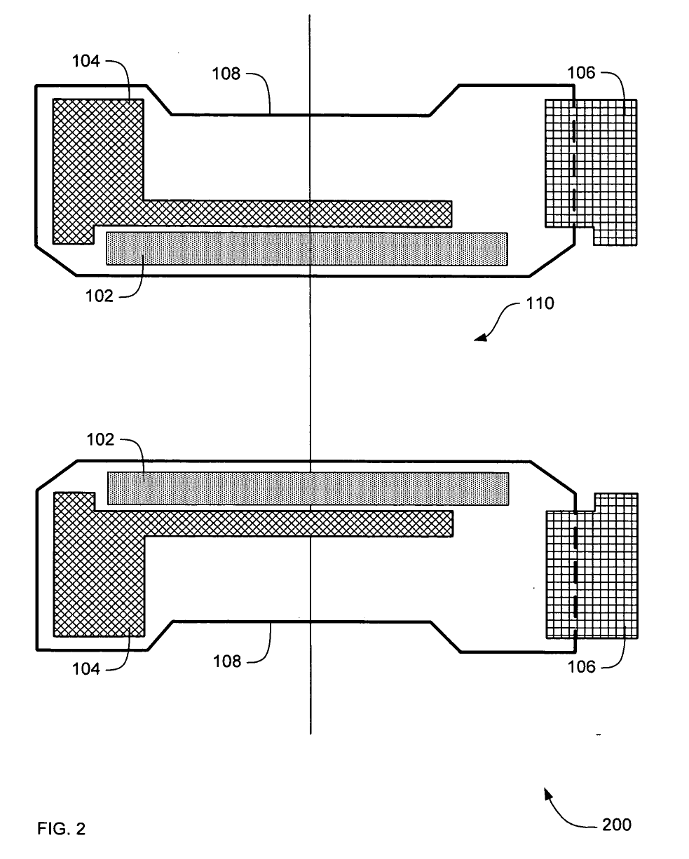

The first cryostat 104 and the second cryostat 106 are separate components and do not exchange fluids such as liquid helium or other liquid coolant. The first cryostat 104 and the second cryostat 106 each house superconducting magnet components (e.g., superconducting coils) that are used to generate a magnetic field in the patient volume or bore 110. The gradient coil 102 is positioned radially inward of the first cryostat 104 and the second cryostat 106 and is used to generate magnetic field gradient pulses used for spatially encoding acquired signals. At least one of the first cryostat 104 and the second 106 cryostat is removable from the housing as shown in FIG. 2. FIG. 2 is a simplified cross section block diagram of a magnetic resonance imaging (MRI) system having at least two cryostats, according to an embodiment. In FIG. 2, the second cryostat 106 is shown being separated and unmounted from the housing 108. In an alternative embodiment, both cryostats 104, 106 may be separable and removable from the housing 108.

Returning to FIG. 1, as mentioned, the first cryostat 104 and the second cryostat 106 are separate components. The first cryostat 104 and the second cryostat 106 are shown with an asymmetrical split so that the first cryostat 104 and the second cryostat 106 do not have the same dimensions. In alternative embodiments, the first cryostat 104 and the second cryostat 106 may have similar or the same dimensions. Preferably, at least one of the cryostats 104, 106 has dimensions that allow the cryostat to be removed from the housing 108, as shown in FIG. 2. In an embodiment, at least one of the cryostats 104, 106 has dimensions that allow the cryostat to pass through a conventional-sized doorway, for example, a doorway of approximately 3.0 feet by 6.5 feet. Accordingly, transporting such cryostats to and from the site of the MRI system 100 does not necessarily require dismantling of the doorways and walls of the room in which the system is located. The dimensions of the separate cryostats 104, 106 provide easier maneuverability and transportation (e.g., less mechanical force may be required) when accessing and removing or replacing the cryostats. The separate cryostats 104, 106 also provide easier access to the gradient coil 102. Accordingly, the maintenance of the MRI system 100, gradient coil 102 and cryostats 104, 106 may be more convenient. The separate (or split) cryostat configuration provides access to portions of the MRI system such as the cryostats (and the magnet components contained therein) and the gradient coil 102 for maintenance, repair and upgrading. For example, the second cryostat 106 may be removed, as shown in FIG. 2), to access the gradient coil 102 for fitting, removal or replacement. Alternatively, the cryostats 104, 106 may be removed for maintenance.

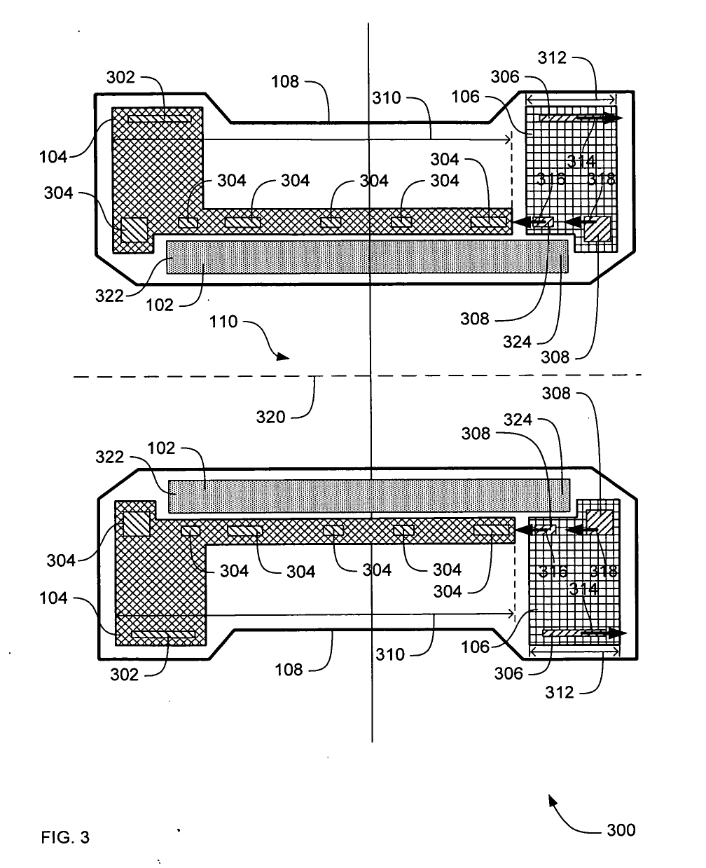

As mentioned above, the first cryostat 104 and the second cryostat 106 each contain superconducting magnet components that are used to generate a magnetic field in the patient volume or bore 110. FIG. 3 is a simplified cross section block diagram of a magnetic resonance imaging (MRI) system having two sections of a superconducting coil enclosed in separate cryostats, according to an embodiment. The MRI system 300 includes a first cryostat 104 and a second cryostat 106. The first cryostat 104 has a first length 310 and contains a first bucking (or shielding) coil 302 and a first section 304 of a primary superconducting coil. The terms primary coil and primary superconducting coil are used throughout to denote coils located on an inner radius of the cylindrical cryostats. The first section 304 of the primary superconducting coil is operable to generate a magnetic field. The second cryostat 106 has a second length 312 and contains a second bucking (or shielding) coil 306 and a second section 308 of the primary superconducting coil. The second section 306 of the primary superconducting coil is operable to generate a magnetic field. The primary superconducting coil for the MRI system 300 is composed in aggregate from the plurality of sections of the primary superconducting coil. For example, in FIG. 3, the primary superconducting coil is composed in aggregate of the first section 304 of the primary superconducting coil and the second section 308 of the primary superconducting coil.

Similar to system 200 in FIG. 2 above, in FIG. 3, at least one of the two cryostats 104, 106, and thus one of the two section(s) of the superconducting coil are removable from the housing 108 and the MRI system 300. In FIG. 3, the first length 310 of the first cryostat 104 and the second length 312 of the second cryostat 106 are different, illustrating an asymmetrical split of the superconducting coils. However, MRI system 300 is not limited by any particular length of the cryostats 104, 106 or sections of superconducting coil. In alternative embodiments, the cryostats 104, 106 may have similar or the same lengths.

Preferably, the coils within each of the plurality of cryostats have a net balanced axial magnetic force so that there is no (or little) net attractive force between the plurality of cryostats. To provide a net balanced axial magnetic force, the bucking coil(s) in a particular cryostat have an axial magnetic force about equal and opposite to an axial magnetic force of the primary superconducting coil in that particular cryostat. Thus, the equal (or about equal) and opposite magnetic forces of the bucking coils and the primary superconducting coils yield a net balanced axial magnetic force within each cryostat, or a near balanced axial force within each cryostat. For example, in the first cryostat 104 the bucking coil 302 has an axial magnetic force about equal and opposite to an axial magnetic force of the first section 304 of the primary superconducting coil. In another example, in the second cryostat the bucking coil 306 has an axial magnetic force 314 about equal and opposite to an axial magnetic force 316, 318 of the second section 308 of the primary superconducting coil. The balanced axial magnetic force of the coils in each cryostat yields a net axial magnetic force of about zero. Accordingly, the cryostats 104 and 106 are not imparting significant magnetic force upon each other.

In order to balance the axial force acting on a given section of the superconducting coil, a cryostat may include at least one coil in which the current flow is opposite to that in adjoining coils. For example, the coils in a cryostat inboard of end coils in the cryostat may be reversed coils to enable a net balanced axial magnetic force within the cryostat. In addition, such reversed flow in combination with a relatively large number of coils (e.g., more than 6 coils) enables the use of a short, yet homogeneous primary coil geometry.

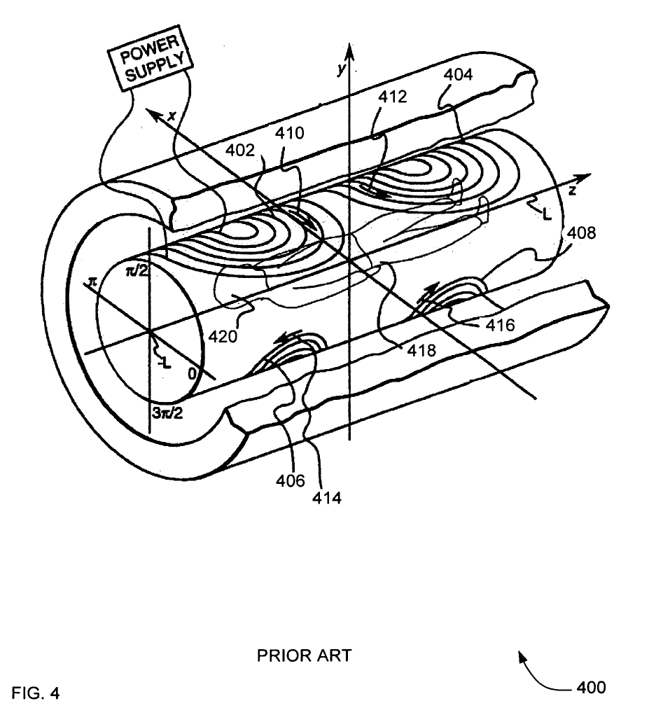

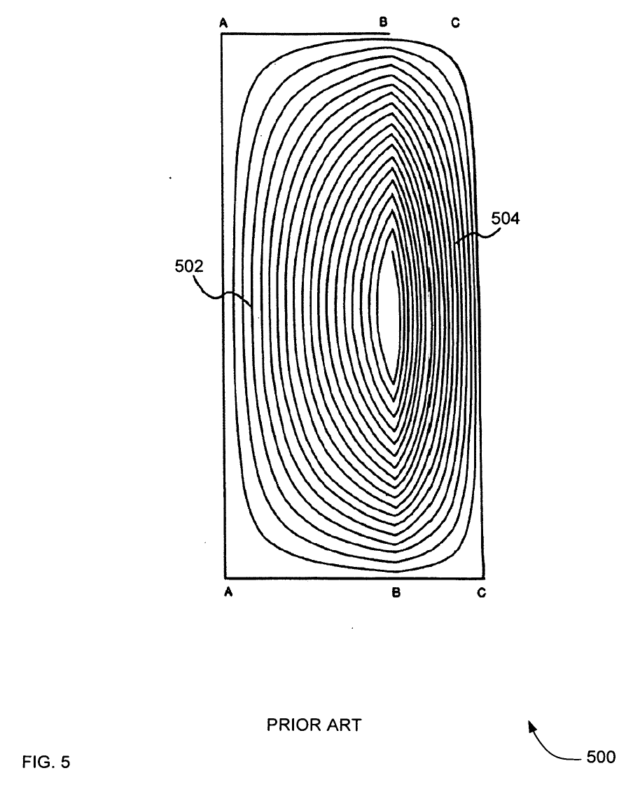

The separate cryostat configuration (as described above) using a plurality of cryostats is compatible with efficient primary superconducting coil geometries. For example, a short magnet system is obtained by turns of the primary superconducting coil that are arranged in a U-shaped geometry with the opening of the “U” facing a longitudinal axis 320 of the MRI system 300. At least a portion of the first cryostat 104 is positioned at first end 322 of the gradient coil 102 and at least a portion of the second cryostat 106 is positioned at a second end 324 of the gradient coil 102. As a result at least a portion of the gradient coil 102 is located between the two cryostats 104, 106. In this configuration, the magnetic field generated by the primary coil has a very high degree of homogeneity and the size of the “U”-shaped geometry remains sufficiently large. The “U” configuration of the primary (inner) coils reduces the length of the primary coils and/or improves homogeneity while still providing sufficient space to house the gradient coil. In the “U” configuration, by using separable sections (e.g., sections 304, 308 shown in FIG. 3) of the primary coil, the gradient coil 102 is not physically trapped by the primary coils, thus the gradient coil can be readily repaired or replaced.

Where a “U”-shaped geometry for the primary superconducting coils is implemented, some embodiments include a gradient coil geometry with reduced axial extent such that the gradient coil can nest between the end primary coils. FIGS. 4-8 describe exemplary shortened gradient coil configurations that are compatible with the MRI system of FIGS. 1-3. FIG. 4 is an isometric diagram of a conventional transverse Golay gradient coil 400 that is compatible with the MRI system of FIGS. 1-3, according to an embodiment. The transverse gradient coil 400 has four quadrants each of which have a “fingerprint” winding pattern 402, 404, 406, 408, similar to that shown in FIG. 5. Current flows according to, or opposite arrows 410, 412, 414 and 416. Quadrants 402, 404, 406 and 408 are electrically connected in series with each other. FIG. 4 also includes a subject 418 and a magnet means 420.

FIG. 5 is a cross section diagram of a conventional transverse Golay gradient coil 500 that is compatible with the MRI system of FIGS. 1-3, according to an embodiment. In each of the “fingerprint” coils of FIG. 4, a surface current is designed to pass through a region 502 from A to B to cause a magnetic field to be produced. The current path passing through a region 502 from A to B is designed to provide the desired magnetic field gradient. The region 504 from B to C is necessary to provide a current return path, completing the circuit. The return path in region 504, however, increases the power dissipation and gradient coil length without providing a useful imaging gradient. However, in the example of the return path in region 504, the return path region has more tightly packed turns in order to provide a slightly reduced gradient coil length without compromising the field linearity.

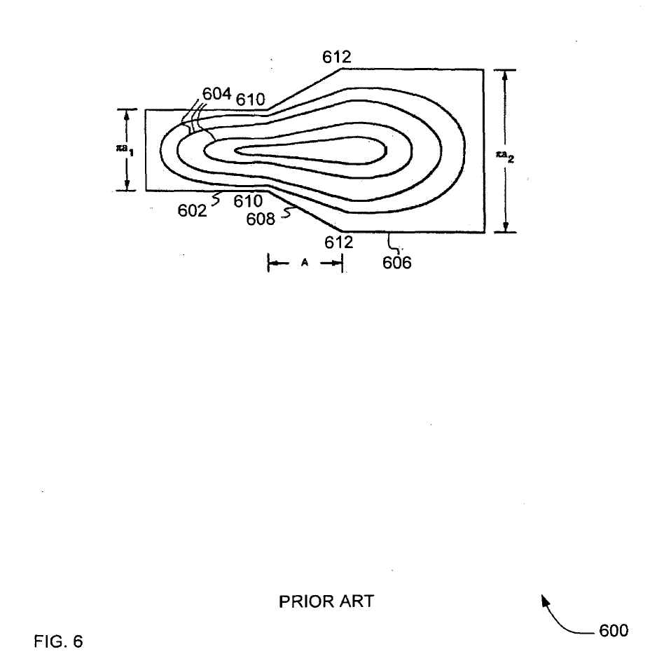

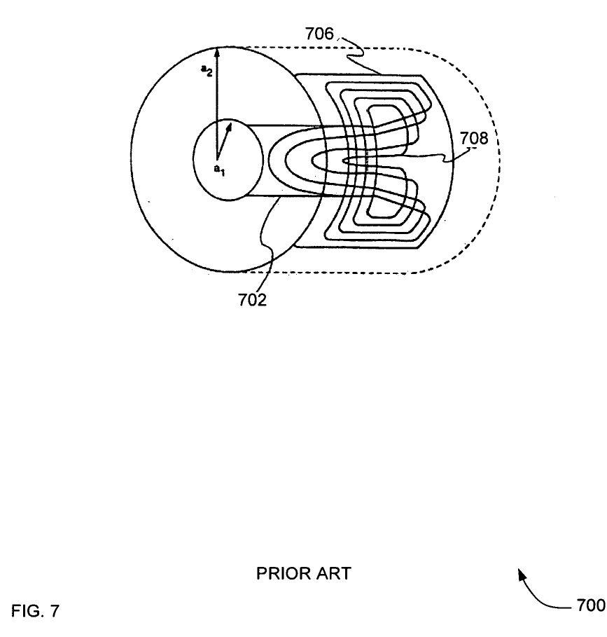

FIG. 6 and FIG. 7 are cross section diagrams of a transverse folded single layer continuous gradient coil 600 that is compatible with the MRI system of FIGS. 1-3, according to an embodiment. A transverse folded single layer continuous gradient coil geometry is more efficient and has reduced axial extent, which could be particularly advantageous when implemented in conjunction with a “U”-shaped primary coil geometry. Gradient coil 600 includes a first region 602 having a plurality of half-loops 604 for carrying a current, a second region 606 having a plurality of half-loops also for carrying a current, and a third region 608 having conductors which connect each half-loop 604 with a corresponding half-loop to create a single gradient coil 600. Gradient coil 600 is intended to be folded or bent along the lines 610 and 612 to result in a shape which is disposed upon two cylinders of radii a.sub.1, and a.sub.2, as shown in FIG. 7. Section 602 is disposed upon a cylinder of radius a.sub.1, while section 606 is disposed upon a cylinder of radius a.sub.2. Section 608 is an intermediate used to link individual current paths of sections 602 and 606, connecting each turn of section 602 at radius a.sub.1 to each corresponding turn of section 606 at radius a.sub.2. This complication can be solved by appropriately soldering and supporting a connecting wire between each turn of coils at radius a.sub.1 to those of radius a.sub.2.

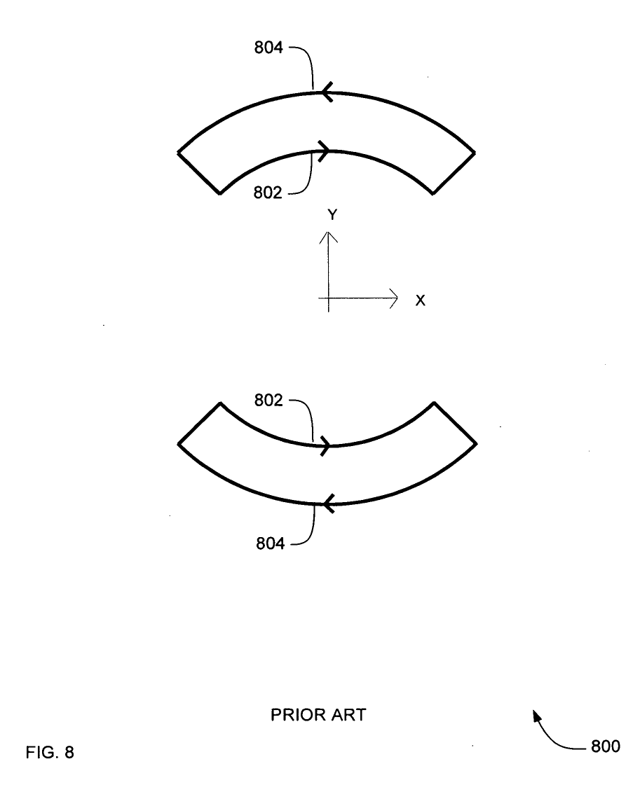

FIG. 8 is cross section diagram of a crescent gradient coil 800 that is compatible with the MRI system of FIGS. 1-3, according to an embodiment. The crescent gradient coil 800 includes a first radius 802 and a second radius 804. In crescent gradient coil 800, a return path for forward arcs is on the second radius 804, reducing the axial extent of the gradient and thereby making the crescent geometry advantageous when implemented in conjunction with a “U”-shaped primary coil geometry. To further enhance performance, a crescent gradient coil may be combined with a more conventional Golay gradient coil, whereby some forwards arcs have a return path on the second radius and some forward arcs have a return path on the same radius.

A separable superconducting coil magnetic resonance imaging (MRI) system is described. Although specific embodiments are illustrated and described herein, it will be appreciated by those of ordinary skill in the art that any arrangement which is calculated to achieve the same purpose may be substituted for the specific embodiments shown. This application is intended to cover any adaptations or variations.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future coil, different cryostats, and new MRI systems.

The terminology used in this application is meant to include all MRI systems, cryostats and magnetic coils and alternate technologies which provide the same functionality as described herein

I claim:

1. An apparatus comprising:
a first section of a superconducting coil operable to generate a magnetic field, the first section of the superconducting coil contained in a first cryostat; and
a second section of the superconducting coil, the second section of the superconducting coil contained in a second cryostat.

2. The apparatus of claim 1, wherein at least one of the first section of the superconducting coil and the second section of the superconducting coil are removable from the apparatus.

3. The apparatus of claim 1, wherein the first section of the superconducting coil and the second section of the superconducting coil are arranged in a U-shaped geometry.

4. The apparatus of claim 1, wherein the first section of superconducting coil further comprises a first primary coil and the second section of superconducting coil comprises a second primary coil.

5. The apparatus of claim 4, wherein the first cryostat further comprises a first bucking coil and the second cryostat further comprises a second bucking coil.

6. The apparatus of claim 5, wherein the first bucking coil has an axial magnetic force about equal and opposite to an axial magnetic force of the first primary coil.

7. The apparatus of claim 5, wherein the second bucking coil has an axial magnetic force about equal and opposite to an axial magnetic force of the second primary coil.

8. A system comprising:
a plurality of cryostats, each cryostat containing a section of a superconducting coil operable to generate a magnetic field; and
a gradient coil positioned at a radius inward of the plurality of cryostats.

9. The system of claim 8, wherein the system further comprises:
a first bucking coil contained in a first cryostat of the plurality of cryostats; and
a second bucking coil contained in a second cryostat of the plurality of cryostats.

10. The system of claim 9, wherein the first cryostat further comprises a first section of the superconducting coil and the first bucking coil has an axial magnetic force about equal and opposite to a magnetic force of the first section of the superconducting coil.

11. The system of claim 8 wherein the superconducting coil is arranged in a U-shaped geometry.

12. The system of claim 8, wherein the at least one of the plurality of cryostats is removable from the system.

13. A magnetic resonance imaging system comprising:
a gradient coil;
a first cryostat having at least a portion positioned at a first end of the gradient coil, the first cryostat containing a first set of superconducting coils comprising a first bucking coil and a first section of a primary coil, the first section of the primary coil being operable to generate a magnetic field;
a second cryostat having at least a portion positioned at a second end of the gradient coil, the second cryostat containing a second set of superconducting coils comprising a second bucking coil and a second section of the primary coil, the second section of the primary coil being operable to generate a magnetic field; and
wherein at least one of the first set of superconducting coils and the second set of superconducting coils are removable from the magnetic resonance imaging system.

14. The magnetic resonance imaging system of claim 13, wherein the first bucking coil has an axial magnetic force about equal and opposite to an axial magnetic force of the first section of the primary coil.

15. The magnetic resonance imaging system of claim 13, wherein the first section of the primary coil and the second section of the primary coil are arranged in a U-shaped geometry.

16. The magnetic resonance imaging system of claim 13, wherein the bucking coil of the first cryostat has an axial magnetic force about equal and opposite to an axial magnetic force of the first section the primary coil.

17. The magnetic resonance imaging system of claim 13, wherein the bucking coil of the second cryostat has an axial magnetic force about equal and opposite to an axial magnetic force of the second section of the primary coil.
